(19) United States
(12) Patent Application Publication
(10) Pub. No.: US 2026/0259359 A1
(43) Pub. Date: Sep. 3, 2026

(54) POLARIZATION CONVERSION ELEMENT

(71) Applicant: NEC Corporation, Tokyo (JP)

(72) Inventor: Ryo Maruyama, Tokyo (JP)

(73) Assignee: NEC Corporation, Tokyo (JP)

(21) Appl. No.: 19/543,118

(22) Filed: Feb. 18, 2026

(30) Foreign Application Priority Data
Feb. 28, 2025 (JP) 2025-031111

(51) Int. Cl. G02B 5/30

(52) U.S. Cl. CPC G02B 5/3025

(57) ABSTRACT

An optical waveguide and a low refractive index layer extend in a first direction and have a second direction as width directions. The low refractive index layer is wider and has a refractive index lower than the optical waveguide separated from the optical waveguide in a third direction. In the first region, the optical waveguide’s width is a width that selectively guides the light of the fundamental mode. In the second region, the optical waveguide’s width and the low refractive index layer’s width expand toward the emission side. In the third region, the optical waveguide’s width and the low refractive index layer’s width are constant. In the fourth region, the optical waveguide’s width expands toward the emission side, and the low refractive index layer’s width is constant. In the fifth region, the optical waveguide’s width is constant, and the low refractive index layer’s width reduces toward the emission side.

### INCORPORATION BY REFERENCE

This application is based upon and claims the benefit of priority from Japanese patent application No. 2025-31111, filed on February 28, 2025, the disclosure of which is incorporated herein in its entirety by reference.

### TECHNICAL FIELD

The present disclosure relates to a polarization conversion element.

### BACKGROUND ART

In recent years, research and development on silicon photonics have been actively conducted. In silicon photonics, light is efficiently and strongly confined by a waveguide including silicon (Si) having a refractive index of about 3.5, so that an optical circuit can be dramatically downsized. On the other hand, in the Si waveguide, separation or conversion of polarized waves to be guided is one of important functions of the optical circuit. A polarization conversion element is an element that outputs a polarized wave orthogonal to the input polarization. In order to cause polarization conversion in a waveguide type polarization conversion element, it is necessary to impart asymmetry in the vertical direction of the cross-sectional structure of the waveguide. There is a feature that a waveguide structure having larger asymmetry has a more expanded design range of dimensions of the waveguide for polarization conversion. That is, this means that a waveguide structure having larger asymmetry is a polarization conversion element having a more robust structure.

For example, in JP 2015-169766 A and “Long Chen, et al., “Compact polarization rotator on silicon for polarization-diversified circuits,” Optics Letters, Vol. 36, No. 4, pp. 469-471, 2011.”, polarization conversion elements using a Si waveguide structure are proposed. In “Long Chen, et al., “Compact polarization rotator on silicon for polarization-diversified circuits,” Optics Letters, Vol. 36, No. 4, pp. 469-471, 2011.”, a silicon nitride (SiN) layer having a tapered shape is formed in an upper layer region of a Si waveguide, whereby asymmetry of a waveguide cross-sectional structure is achieved. In “Long Chen, et al., “Compact polarization rotator on silicon for polarization-diversified circuits,” Optics Letters, Vol. 36, No. 4, pp. 469-471, 2011.”, a Si₃N₄ layer in a polarization conversion (Polarization rotator) region is formed at a position away from immediately above the Si waveguide. Since the Si₃N₄ layer in the structure of “Long Chen, et al., “Compact polarization rotator on silicon for polarization-diversified circuits,” Optics Letters, Vol. 36, No. 4, pp. 469-471, 2011.” has a left-right asymmetric shape, the position of the Si₃N₄ layer with respect to the Si waveguide greatly affects polarization conversion. Thus, in “Long Chen, et al., “Compact polarization rotator on silicon for polarization-diversified circuits,” Optics Letters, Vol. 36, No. 4, pp. 469-471, 2011.”, polarization conversion efficiency with respect to an offset from a design position of the Si₃N₄ layer has been studied. In “Long Chen, et al., “Compact polarization rotator on silicon for polarization-diversified circuits,” Optics Letters, Vol. 36, No. 4, pp. 469-471, 2011.” it is reported that a polarization conversion efficiency equal to or more than 90% is achieved in a range where an amount of offset from the design position of the Si₃N₄ layer is ±15 nm.

### SUMMARY

In “Long Chen, et al., “Compact polarization rotator on silicon for polarization-diversified circuits,” Optics Letters, Vol. 36, No. 4, pp. 469-471, 2011.”, influence of positional deviation of the Si₃N₄ layer in the polarization conversion element on the polarization conversion efficiency has been studied. On the other hand, influence of manufacturing error of the Si waveguide on the polarization conversion efficiency has not been studied. However, since the Si waveguide is a structure itself that guides light, the Si waveguide is an element that greatly affects the polarization conversion efficiency. In the polarization conversion element, a robust design is therefore required against variation in width caused by the manufacturing error of the Si waveguide.

A polarization conversion element that is one aspect of the present disclosure includes an optical waveguide extending in a first direction and having, as a width direction, a second direction orthogonal to the first direction in a cross section perpendicular to the first direction, and a low refractive index layer having a refractive index lower than a refractive index of the optical waveguide, the low refractive index layer extending in the first direction and having, as a width direction, the second direction in the cross section perpendicular to the first direction and being provided to be separated from the optical waveguide in a third direction orthogonal to the first and second directions and to overlap a part of the optical waveguide as viewed along the third direction, in which the optical waveguide is divided into a first region, a second region, a third region, a fourth region, and a fifth region from an incident side toward an emission side of light along the first direction, and the low refractive index layer is provided between an end portion on the incident side of the light of the second region and an end portion on the emission side of the light of the fifth region in such a way as to extend with a width wider than a width of the optical waveguide, and in the first region, the width of the optical waveguide is a width at which light in a fundamental mode is selectively guided, and in the second region, the width of the optical waveguide expands from the incident side toward the emission side of the light, and a width of the low refractive index layer expands from the incident side toward the emission side of the light, and in the third region, widths of the optical waveguide and the low refractive index layer are equal to respective widths at an end portion on the emission side of the light of the second region, and in the fourth region, the width of the optical waveguide expands from the incident side toward the emission side of the light, and the width of the low refractive index layer is equal to the width in the third region, and in the fifth region, the width of the optical waveguide is equal to a width at an end portion on the emission side of the light of the fourth region, and the width of the low refractive index layer reduces from the incident side toward the emission side of the light.

According to the present disclosure, it is possible to provide a polarization conversion element capable of suppressing influence on polarization conversion efficiency due to variation in width of an optical waveguide.

### BRIEF DESCRIPTION OF THE DRAWINGS

FIG. 1 is a perspective view schematically illustrating a configuration of a polarization conversion element according to one example embodiment;

FIG. 2 is a top view schematically illustrating the configuration of the polarization conversion element according to one example embodiment;

FIG. 3 is a top view illustrating a modified example of the polarization conversion element according to one example embodiment;

FIG. 4 is a diagram illustrating dependency of polarization conversion efficiency on variation in width of an optical waveguide;

FIG. 5 is a diagram illustrating wavelength dependency of polarization conversion efficiency;

FIG. 6 is a diagram illustrating dependency of polarization conversion efficiency on variation in width of an optical waveguide;

FIG. 7 is a diagram illustrating wavelength dependency of polarization conversion efficiency;

FIG. 8 is a diagram illustrating dependency of polarization conversion efficiency on variation in width of an optical waveguide;

FIG. 9 is a diagram illustrating wavelength dependency of polarization conversion efficiency;

FIG. 10 is a diagram illustrating dependency of polarization conversion efficiency on variation in width of an optical waveguide; and

FIG. 11 is a diagram illustrating wavelength dependency of polarization conversion efficiency.

### EXAMPLE EMBODIMENT

Hereinafter, example embodiments of the present disclosure will be described with reference to the drawings. In the drawings, the same elements are denoted by the same reference signs, and redundant description will be omitted as necessary.

Hereinafter, the term “one example embodiment” means that it is applicable to any of the example embodiments described below or a combination of two or more example embodiments, and the application is not limited to a specific example embodiment.

### First Example Embodiment

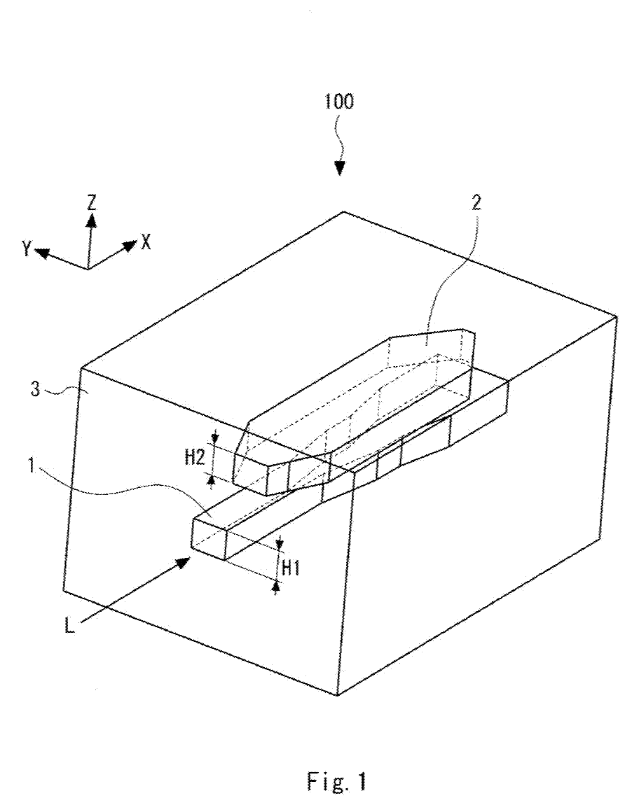

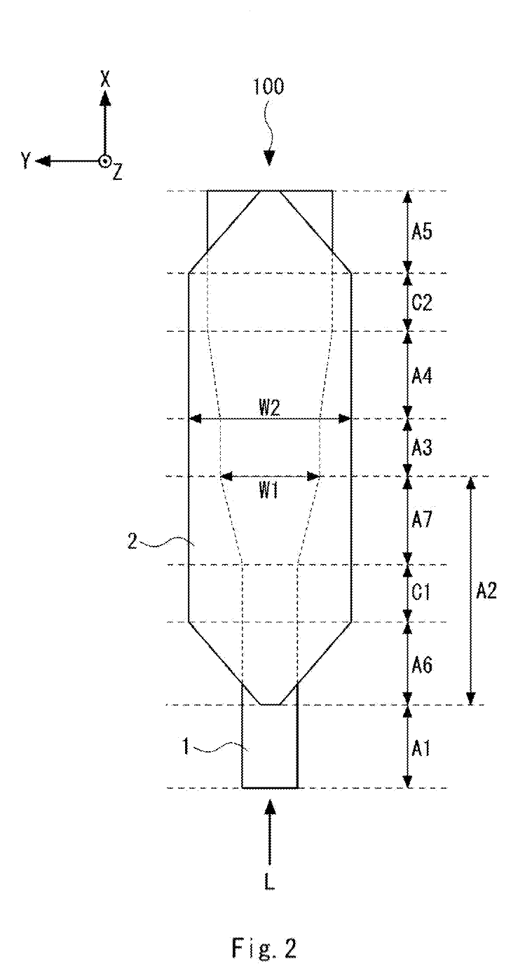

A polarization conversion element according to a first example embodiment will be described. The polarization conversion element according to the first example embodiment is configured as, for example, a silicon photonics element. FIG. 1 is a perspective view schematically illustrating a configuration of a polarization conversion element according to one example embodiment. FIG. 2 is a top view schematically illustrating the configuration of the polarization conversion element according to one example embodiment. A polarization conversion element 100 includes three layers of an optical waveguide 1, a low refractive index layer 2, and a clad layer 3.

Hereinafter, in order to facilitate understanding of the configuration of the polarization conversion element, an XYZ coordinate system defined by an X axis, a Y axis, and a Z axis orthogonal to each other is introduced into the display in the drawing. An axis in an extending direction of the optical waveguide 1 and the low refractive index layer 2 is defined as the X axis. An axis in a direction of principal surfaces of the optical waveguide 1 and the low refractive index layer 2 is defined as the Z axis. An axis in a direction orthogonal to an X-axis direction on the principal surfaces of the optical waveguide 1 and the low refractive index layer 2 is defined as the Y axis. Hereinafter, X, Y, and Z directions mean directions along the X axis, the Y axis, and the Z axis, respectively, and it does not matter which of the - direction and the + direction of each axis is directed. Directions toward the + direction of the respective axes are denoted as a +X direction, a +Y direction, and a +Z direction. Directions toward the - direction of the respective axes are denoted as a -X direction, a -Y direction, and a -Z direction. The X direction is also referred to as a first direction. The Y direction is also referred to as a second direction. The Z direction is also referred to as a third direction.

The optical waveguide 1 is an optical waveguide including, for example, silicon (Si). The optical waveguide 1 is configured as an optical waveguide extending along the X direction. A width in the Y direction of the optical waveguide 1 increases stepwise from the end portion on the -X direction side toward the end portion on the +X direction side. The optical waveguide 1 has a line-symmetric shape with respect to the central axis in the X direction as viewed along the Z direction. Hereinafter, a length of the optical waveguide 1 refers to a dimension of the optical waveguide 1 in the X direction that is the extending direction of the optical waveguide 1. A width of the optical waveguide 1 refers to a dimension in the Y direction of the optical waveguide 1. A thickness of the optical waveguide 1 refers to a dimension in the Z direction of the optical waveguide 1.

Light L is incident on the optical waveguide 1 from the end portion on the -X direction side. The light L incident on the optical waveguide 1 is subjected to polarization conversion by structures and arrangement of the optical waveguide 1 and the low refractive index layer 2 while propagating through the optical waveguide 1. The light L after the polarization conversion is emitted from the end portion on the +X direction side of the optical waveguide 1.

Hereinafter, in each configuration and each region, the -X direction side is also referred to as an incident side of the light L, and the +X direction side is also referred to as an emission side of the light L.

The low refractive index layer 2 is an optical waveguide including, for example, silicon nitride. As a composition of silicon nitride, Si₃N₄ or the like is known, but the composition is not limited thereto. The low refractive index layer 2 only needs to include a material having a refractive index lower than that of the optical waveguide 1 and higher than that of the clad layer 3, and the material included in the low refractive index layer 2 is not limited to silicon nitride.

The low refractive index layer 2 is configured as an optical waveguide extending along the X direction. A width in the Y direction of the low refractive index layer 2 increases stepwise from the end portion on the -X direction side toward the end portion on the +X direction side. The low refractive index layer 2 has a line-symmetric shape with respect to the central axis in the X direction as viewed from the Z direction. The low refractive index layer 2 is arranged to be separated from the optical waveguide 1 in the +Z direction. That is, the optical waveguide 1 and the low refractive index layer 2 are arranged to be separated from each other along the Z direction. The low refractive index layer 2 is provided so that the central axis in the X direction coincides with the central axis in the X direction of the optical waveguide 1 as viewed along the Z direction.

Hereinafter, a length of the low refractive index layer 2 refers to a dimension of the low refractive index layer 2 in the X direction that is the extending direction of the low refractive index layer 2. A width of the low refractive index layer 2 refers to a dimension in the Y direction in a Z-Y cross section of the low refractive index layer 2. A thickness of the low refractive index layer 2 refers to a dimension of the low refractive index layer 2 in the Z direction.

The optical waveguide 1 and the low refractive index layer 2 are embedded in the clad layer 3. The clad layer 3 includes, for example, a quartz-based material such as SiO₂. The clad layer 3 only needs to include a material having a refractive index lower than those of the optical waveguide 1 and the low refractive index layer 2, and is not limited to a quartz-based material such as SiO₂. As long as desired polarization conversion can be achieved by the polarization conversion element 100, the clad layer 3 may include any material having a low refractive index lower than those of the optical waveguide 1 and the low refractive index layer 2, such as air.

Next, the widths of the optical waveguide 1 and the low refractive index layer 2 will be described. The polarization conversion element 100 is divided into a plurality of regions along the X direction. The widths of the optical waveguide 1 and the low refractive index layer 2 are configured so that the widths vary depending on the region. In the present example embodiment, division is made into at least five regions of a first region A1 to a fifth region A5 sequentially from the end portion on the incident side toward the end portion on the emission side.

The first region A1 is a region in which only the optical waveguide 1 extends and the low refractive index layer 2 does not exist. On the other hand, the second region A2 to the fifth region A5 are regions in which both the optical waveguide 1 and the low refractive index layer 2 extend. The low refractive index layer 2 is configured to have a width wider than that of the optical waveguide 1 between the second region A2 and the fifth region A5. That is, the low refractive index layer 2 is provided so as to overlap a portion extending between the second region A2 and the fifth region A5 of the optical waveguide 1.

An interval in the Z direction between the optical waveguide 1 and the low refractive index layer 2 is desirably equal to or more than 10 nm and equal to or less than 100 nm. Hereinafter, intervals in the Z direction between the optical waveguide 1 and the low refractive index layer 2 are the same between the second region A2 and the fifth region A5. The thickness in the Z direction of the low refractive index layer 2 is desirably about 50 nm to 400 nm.

In the first region A1, the optical waveguide 1 is designed to selectively guide only light in the fundamental mode (TE0 mode, TM0 mode). For example, if the optical waveguide has a height of 220 nm and a width of 400 nm, the light L having a wavelength of 1550 nm propagates through the optical waveguide 1 in a single mode. In the present example embodiment, it is assumed that the light L propagating through the first region A1 satisfies both the TE0 mode and the TM0 mode.

In the second region A2, the optical waveguide 1 and the low refractive index layer 2 are configured so that the widths of the optical waveguide 1 and the low refractive index layer 2 expand. As a result, the light L in the fundamental mode (TE0 mode and TM0 mode) incident from the first region A1 is converted into the light L in a hybrid state of the TM0 mode and the TE1 mode. In the present configuration, the second region A2 is divided so as to have at least a sixth region A6 provided on the incident side of the light L and a seventh region A7 provided on the emission side of the light L. In addition, in the present configuration, a first connection region C1 connecting the sixth region A6 with the seventh region A7 is inserted between the sixth region A6 and the seventh region A7.

In the sixth region A6, the optical waveguide 1 extends with the same width as the optical waveguide 1 in the first region A1. The low refractive index layer 2 is configured to have a tapered shape in which the width contiguously expands from the end portion on the incident side toward the end portion on the emission side. As a result, the width of the end portion on the incident side of the low refractive index layer 2 is narrower than the width of the optical waveguide 1, but the width of the end portion on the emission side of the low refractive index layer 2 is wider than the width of the optical waveguide 1. The width of the end portion on the incident side of the low refractive index layer 2 is desirably as narrow as possible in order to suppress reflection of the incident light L to a desired level or less. For example, the width of the end portion on the incident side of the low refractive index layer 2 is preferably 150 nm, more preferably 120 nm, and still more preferably equal to or less than 100 nm.

The optical waveguide 1 in the first connection region C1 extends with the same width as the optical waveguide 1 in the first region A1 and the sixth region A6. The low refractive index layer 2 extends with the same width as the low refractive index layer 2 at the end portion on the emission side of the sixth region A6. As a result, a mode state of the light L changed by the low refractive index layer 2 having the tapered shape in the sixth region A6 can be stabilized by the first connection region C1 in which the optical waveguide 1 and the low refractive index layer 2 extend with a constant width. As a result, the light L is incident on the next seventh region A7 after the mode state is stabilized in the first connection region C1.

In the seventh region A7, the optical waveguide 1 is configured to have a tapered shape in which the width contiguously expands from the end portion on the incident side toward the end portion on the emission side. The width of the end portion on the incident side of optical waveguide 1 is therefore the same as the width at the end portion on the emission side of the sixth region A6 of the optical waveguide 1. On the other hand, the width of the end portion on the emission side of the optical waveguide 1 is expanded to a width that enables polarization conversion of the mode of the light L from the TM0 mode to the TE1 mode. Here, the width that enables polarization conversion is a width at which equivalent refractive indexes for the TM0 mode and the TE1 mode are substantially the same and that can achieve hybridization of the TM0 mode and the TE1 mode. On the other hand, the low refractive index layer 2 extends with the same width as the low refractive index layer 2 at the end portion on the emission side of the first connection region C1.

In the third region A3, the optical waveguide 1 extends with the same width as the optical waveguide 1 at the end portion on the emission side of the seventh region A7. The low refractive index layer 2 also extends with the same width as the low refractive index layer 2 in the seventh region A7. As a result, in the third region A3, the light L is guided in a state where the TM0 mode and the TE1 mode are hybridized.

As described above, the polarization conversion from the TM0 mode to the TE1 mode occurs due to the seventh region A7 and the third region A3. Polarization conversion efficiency depends on lengths and widths of the seventh region A7 and the third region A3. Perfect polarization conversion (100%) can therefore be achieved in principle by appropriately designing the width and length of the optical waveguide 1 in the seventh region A7 and the third region A3.

In the fourth region A4, the optical waveguide 1 is configured to have a tapered shape in which the width contiguously expands from the end portion on the incident side toward the end portion on the emission side. The width of the end portion on the incident side of the optical waveguide 1 is therefore the same as the width of the end portion on the emission side of the third region A3 of the optical waveguide 1. On the other hand, the width of the end portion on the emission side of the optical waveguide 1 is expanded to a width at which a difference sufficiently occurs in the equivalent refractive indexes of the TM0 mode and the TE1 mode. As a result, the hybrid state of the TM0 mode and the TE1 mode is eliminated, and the TE1 mode becomes dominant in the light L. As a result, light of the TE1 mode is emitted from the optical waveguide 1 in the fourth region A4.

In the present configuration, a second connection region C2 connecting the fourth region A4 with the fifth region A5 is inserted between the fourth region A4 and the fifth region A5. In the second connection region C2, the optical waveguide 1 extends with the same width as the optical waveguide 1 at the end portion on the emission side of the fourth region A4. The low refractive index layer 2 extends with the same width as the low refractive index layer 2 in the fourth region A4. As a result, the mode state of the light L changed by the optical waveguide 1 having the tapered shape in the fourth region A4 can be stabilized by the second connection region C2 in which the optical waveguide 1 and the low refractive index layer 2 extend with constant widths. As a result, the light L is incident on the next fifth region A5 after the mode state is stabilized by the second connection region C2.

In the fifth region A5, the optical waveguide 1 extends with the same width as the optical waveguide 1 in the second connection region C2. The low refractive index layer 2 is configured to have a tapered shape in which the width contiguously reduces from the end portion on the incident side toward the end portion on the emission side. The width of the end portion on the incident side of the low refractive index layer 2 is therefore the same as the width in the second connection region C2. On the other hand, the width of the end portion on the emission side of the low refractive index layer 2 is desirably as narrow as possible in order to suppress reflection of the light L incident on the end portion on the emission side to a desired level or less. The width of the end portion on the emission side of the low refractive index layer 2 is preferably 150 nm, more preferably 130 nm, and still more preferably equal to or less than 100 nm.

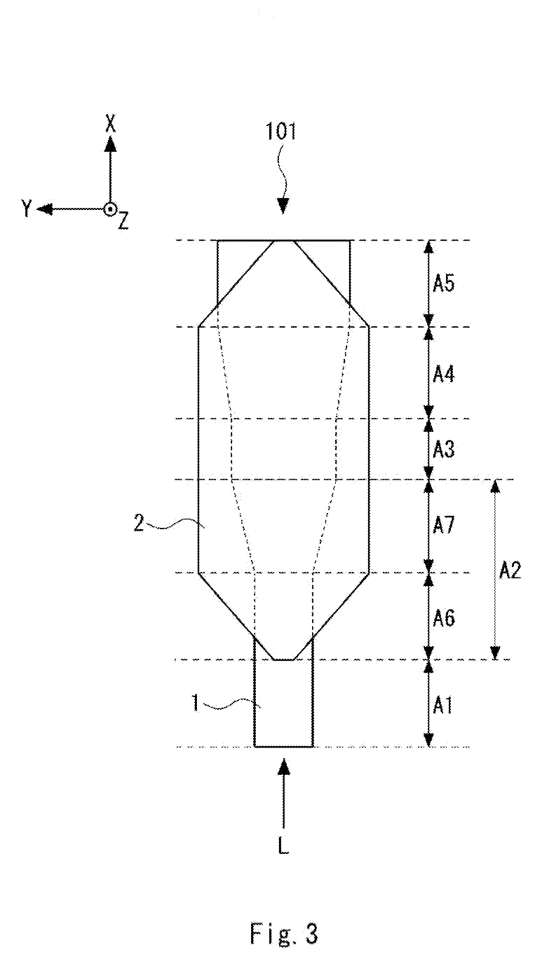

As described above, the first connection region C1 and the second connection region C2 are inserted to stabilize the mode of the guided light. It is therefore desirable that the first connection region C1 and the second connection region C2 are inserted into the polarization conversion element 100. On the other hand, one or both of the first connection region C1 and the second connection region C2 may be omitted as long as the mode of the guided light can be sufficiently stabilized and suitable polarization conversion can be performed. FIG. 3 is a top view illustrating a modified example of the polarization conversion element according to one example embodiment. As a polarization conversion element 101 illustrated in FIG. 3, the first connection region C1 and the second connection region C2 may be omitted, and only the first region A1 and the third region to the seventh region A7 may constitute a polarization conversion element.

In a case where the polarization conversion element 100 is actually produced, the widths and lengths of the optical waveguides 1 in the seventh region A7 and the third region A3 vary with manufacturing variation. The polarization conversion efficiency therefore varies similarly in actual devices. On the other hand, in the polarization conversion element 100, fluctuation in the polarization conversion efficiency is desirably small even if width ratios vary. Thus, in the present configuration, the width of the low refractive index layer 2 in the third region A3 is made wider than the width of the optical waveguide 1, whereby high and stable polarization conversion efficiency is achieved.

Hereinafter, based on simulation, a description will be given of influence on the polarization conversion efficiency by making the width of the low refractive index layer 2 of the third region A3 wider than the width of the optical waveguide 1. In the following simulation, W2/W1, which is a ratio of a width W2 of the low refractive index layer 2 to a width W1 of the optical waveguide 1 in the third region A3, is referred to as a width ratio. First to fourth conditions below were set for a design value of the width ratio. Then, under each condition, the simulation was performed on the influence on the optical waveguide of variation from the design value of the width of the optical waveguide 1 in the third region A3.

It is assumed that the polarization conversion element is used in a wide wavelength range. Thus, in order to achieve high polarization conversion efficiency in the wide wavelength range, simulation was also performed on the wavelength dependency of the polarization conversion efficiency in the C band under each condition.

### First Condition

Under the first condition, the design value of the width ratio of the width W2 of the low refractive index layer 2 to the width W1 of the optical waveguide 1 in the third region A3 was set to 1.0. A ratio of a thickness H2 of the low refractive index layer 2 to a thickness H1 of the optical waveguide 1 was set to 1 : 2. The lengths of the optical waveguide 1 and the low refractive index layer 2 were set to 46 μm.

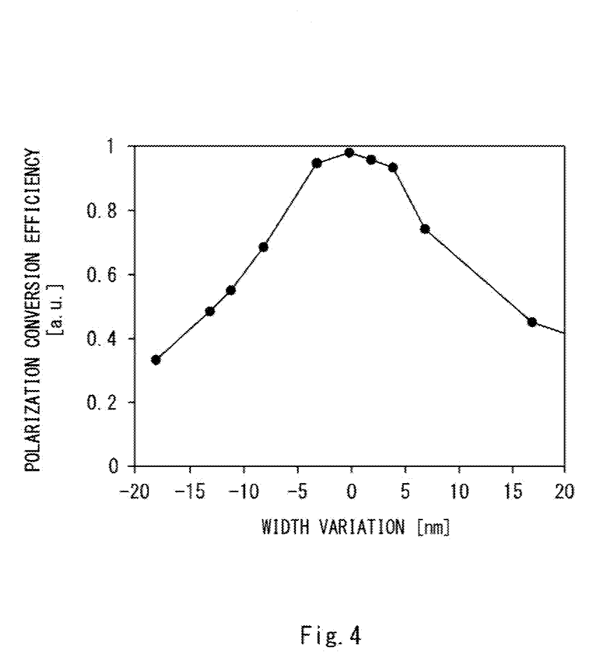

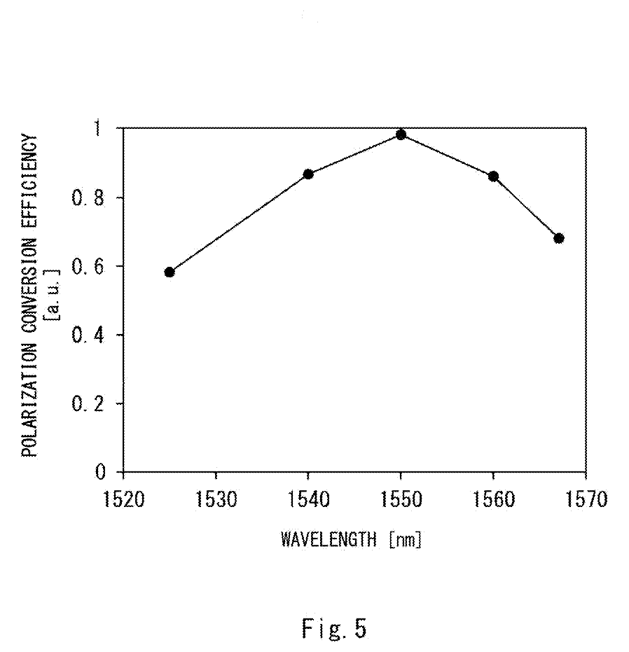

FIG. 4 is a diagram illustrating dependency of polarization conversion efficiency on variation in width of the optical waveguide 1. Under the first condition, in a case where fluctuation of the width W1 of the optical waveguide 1 in the third region A3 was within a range of ±3.5 nm, a polarization conversion efficiency equal to or more than 90% could be achieved. On the other hand, in a case where the fluctuation of the width W1 of the optical waveguide 1 in the third region A3 was within a range equal to or more than ±5.0 nm, the polarization conversion efficiency rapidly decreased. FIG. 5 is a diagram illustrating wavelength dependency of polarization conversion efficiency. In this case, the wavelength dependency of the polarization conversion efficiency was large, and the polarization conversion efficiency decreased to about 60% at a wavelength of 1525 nm.

Under the first condition in which the design value of the ratio of the width W2 of the low refractive index layer 2 to the width W1 of the optical waveguide 1 in the third region A3 is 1.0, it can be seen that a range of the width of the low refractive index layer 2 that can achieve high polarization conversion efficiency is narrow, and the wavelength dependency of the polarization conversion efficiency is large.

### Second Condition

Under the second condition, the design value of the ratio of the width W2 of the low refractive index layer 2 to the width W1 of the optical waveguide 1 in the third region A3 was set to 1.2. The ratio of the thickness H2 of the low refractive index layer 2 to the thickness H1 of the optical waveguide 1 was similarly set to 1 : 2. The lengths of the optical waveguide 1 and the low refractive index layer 2 were set to 26 μm.

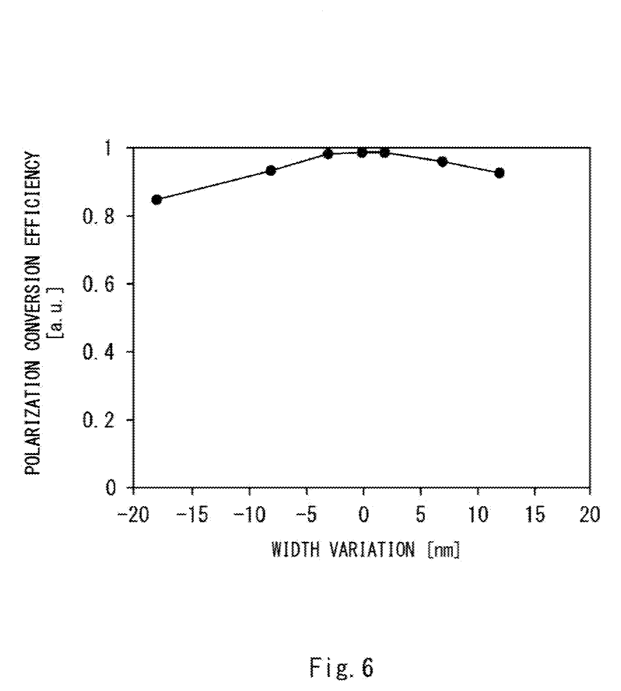

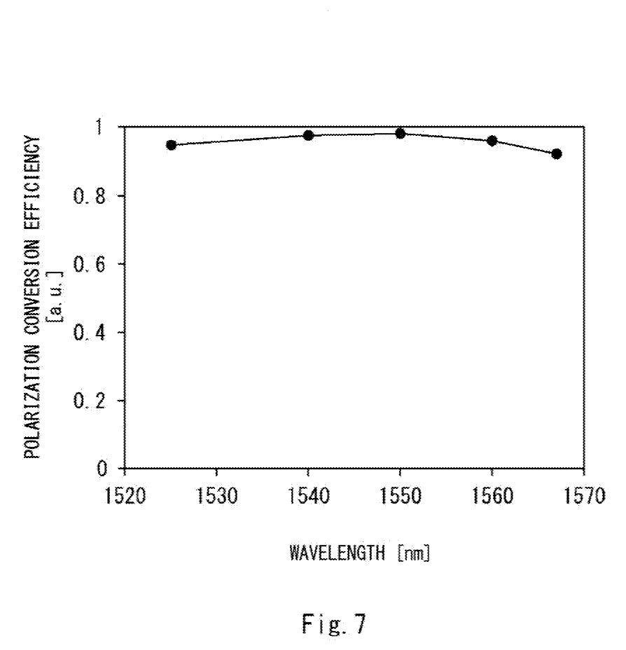

FIG. 6 is a diagram illustrating dependency of polarization conversion efficiency on variation in width of the optical waveguide 1. Under the second condition, in a case where the fluctuation of the width W1 of the optical waveguide 1 in the third region A3 was within a range of ±10 nm, a polarization conversion efficiency equal to or more than 90% could be achieved. FIG. 7 is a diagram illustrating wavelength dependency of polarization conversion efficiency. In this case, the wavelength dependency could also be suppressed to be small, and as a result, a polarization conversion efficiency equal to or more than 90% was achieved in the entire C band.

Under the second condition, the design value of the ratio of the width W2 of the low refractive index layer 2 to the width W1 of the optical waveguide 1 in the third region A3 was increased as compared with that under the first condition. As a result, a variation range of the width of the optical waveguide 1, in which high polarization conversion efficiency can be achieved, was expanded, and the wavelength dependency of the polarization conversion efficiency could be improved.

### Third Condition

Under the third condition, the design value of the ratio of the width W2 of the low refractive index layer 2 to the width W1 of the optical waveguide 1 in the third region A3 was set to 1.6. The ratio of the thickness H2 of the low refractive index layer 2 to the thickness H1 of the optical waveguide 1 was similarly set to 1 : 2. The lengths of the optical waveguide 1 and the low refractive index layer 2 were set to 24 μm.

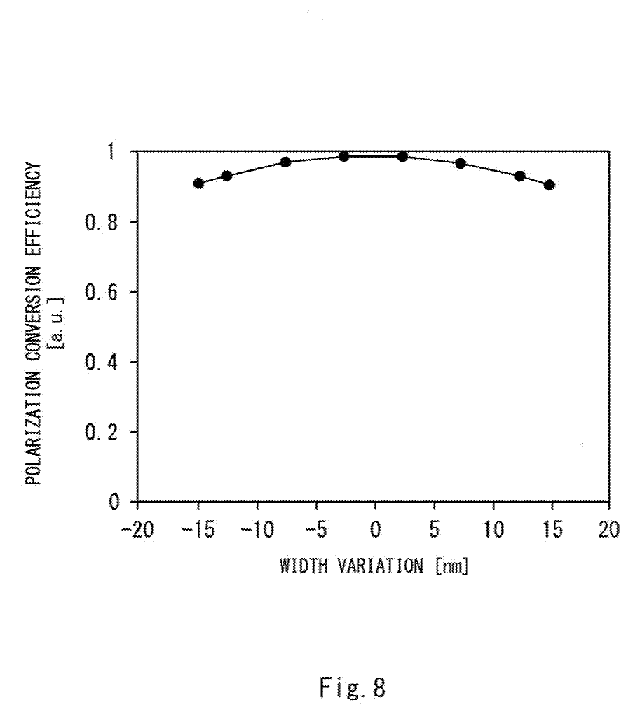

FIG. 8 is a diagram illustrating dependency of polarization conversion efficiency on variation in width of the optical waveguide 1.

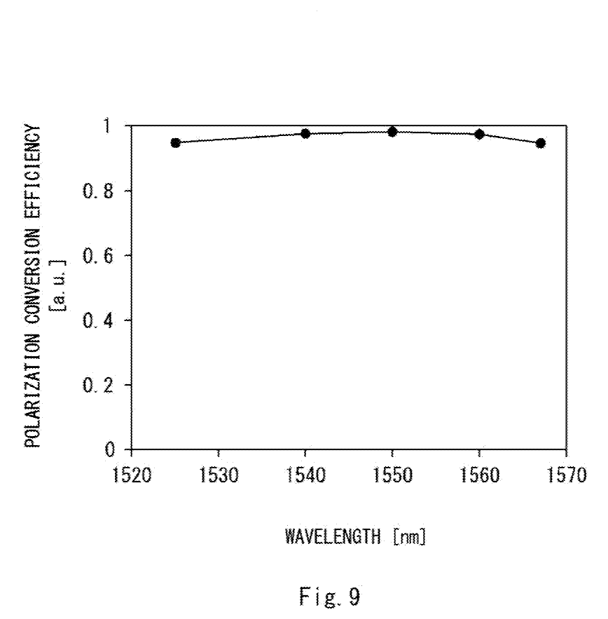

Under the third condition, in a case where the fluctuation of the width W1 of the optical waveguide 1 in the third region A3 was within a range of ±15 nm, a polarization conversion efficiency equal to or more than 90% was achieved. FIG. 9 is a diagram illustrating wavelength dependency of polarization conversion efficiency. In this case, the wavelength dependency could be further suppressed, and as a result, a polarization conversion efficiency equal to or more than 95% was achieved in the entire C band.

Under the third condition, the design value of the ratio of the width W2 of the low refractive index layer 2 to the width W1 of the optical waveguide 1 in the third region A3 was further increased as compared with that under the second condition. As a result, the variation range of the width W1 of the optical waveguide 1, in which the high polarization conversion efficiency can be achieved, was further expanded, and the wavelength dependency of the polarization conversion efficiency could be further improved.

### Fourth Condition

Under the fourth condition, the design value of the ratio of the width W2 of the low refractive index layer 2 to the width W1 of the optical waveguide 1 in the third region A3 was set to 5.5. The ratio of the thickness H2 of the low refractive index layer 2 to the thickness H1 of the optical waveguide 1 was set to 2 : 1. The lengths of the optical waveguide 1 and the low refractive index layer 2 were set to 35 μm.

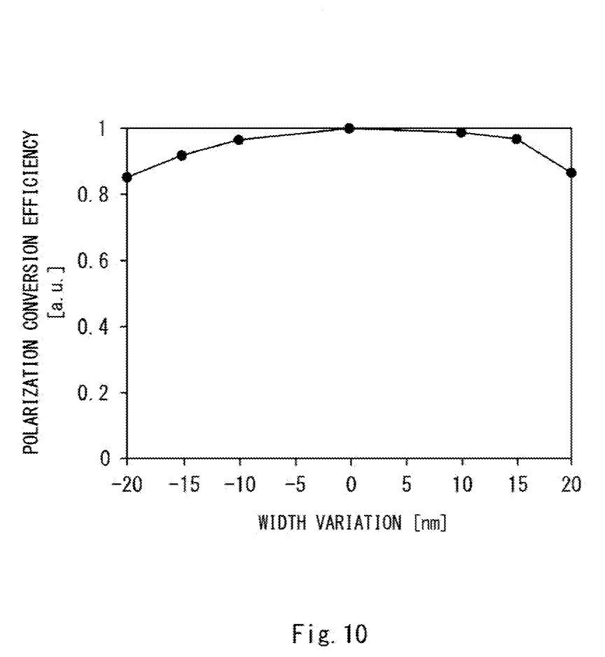

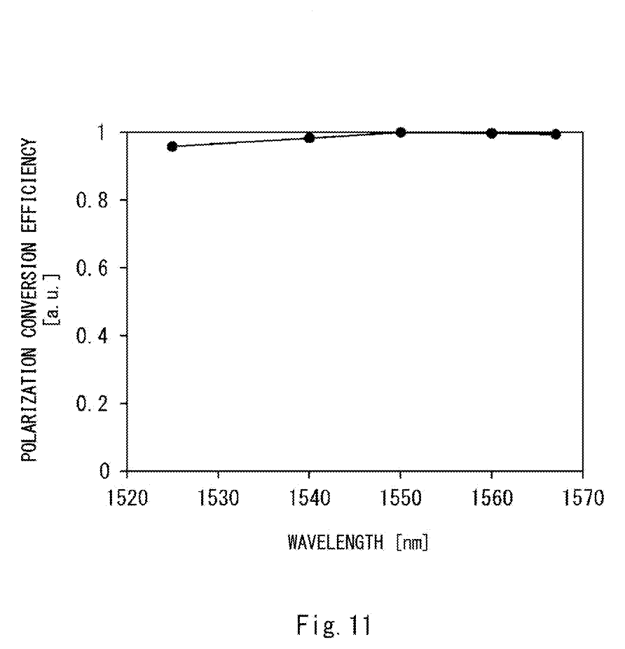

FIG. 10 is a diagram illustrating dependency of polarization conversion efficiency on variation in width of the optical waveguide 1. Under the fourth condition, in a case where the fluctuation of the width W1 of the optical waveguide 1 in the third region A3 was within a range of ±15 nm, a polarization conversion efficiency equal to or more than 90% was achieved. FIG. 11 is a diagram illustrating wavelength dependency of polarization conversion efficiency. In this case, the wavelength dependency could be suppressed to be small, and as a result, a polarization conversion efficiency equal to or more than 95% was achieved in the entire C band.

Under the fourth condition, the design value of the ratio of the width W2 of the low refractive index layer 2 to the width W1 of the optical waveguide 1 in the third region A3 was significantly increased as compared with that under the third condition. As a result, under the fourth condition, polarization conversion efficiency substantially similar to that under the third condition could be achieved.

As described above, in the polarization conversion element 100, by making the width of the low refractive index layer 2 wider than the width of the optical waveguide 1 in the third region A3, it is possible to significantly suppress the fluctuation in the polarization conversion efficiency due to the variation in the width of the optical waveguide 1. According to the polarization conversion element 100, it is therefore possible to suppress the fluctuation in the polarization conversion efficiency caused by the manufacturing variation in the width of the optical waveguide 1.

As described above, according to the polarization conversion element 100, the wavelength dependency of the polarization conversion efficiency can also be suppressed.

It is not necessary to have an asymmetrical shape with respect to a light guide direction like the Si₃N₄ layer provided to be separated from the optical waveguide, as in “Long Chen, et al., “Compact polarization rotator on silicon for

polarization-diversified circuits,” Optics Letters, Vol. 36, No. 4, pp. 469-471, 2011.”, and it is possible to have a symmetrical shape with respect to the light guiding direction. As a result, the low refractive index layer 2 can be more easily manufactured. By forming the low refractive index layer 2 to have a symmetrical structure, even in a case where the center axes of the optical waveguide 1 and the low refractive index layer 2 in the X direction deviate from each other in the Y direction, it is possible to suppress fluctuation in polarization conversion efficiency due to the deviation. As a result, it is possible to prevent in advance a problem of degradation of the polarization conversion efficiency due to deviation between the left and right, which is caused by use of the Si₃N₄ layer having a structure that is not symmetrical in the left and right (Y direction).

### Other Example Embodiments

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

In the example embodiment described above, it has been described that the optical waveguide 1 has the tapered shape in the fourth region A4 and the seventh region A7, but this is merely an example. As long as the width of the optical waveguide 1 can be expanded, the optical waveguide 1 may have any shape whose width changes contiguously or stepwise.

In the example embodiment described above, it has been described that the low refractive index layer 2 has a tapered shape in the fifth region A5 and the sixth region A6, but this is merely an example. As long as the width of the low refractive index layer 2 can be expanded or reduced, the low refractive index layer 2 may have any shape whose width changes contiguously or stepwise.

Although it has been described that the second region is divided into at least the sixth region A6 and the seventh region, this is merely an example. If the width of each of the optical waveguide 1 and the low refractive index layer 2 expands from the incident side toward the emission side, the optical waveguide 1 and the low refractive index layer 2 may have any shape or may be divided into any number of regions.

Each drawing is merely illustrative for describing one or more example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings to describe illustrative example embodiments are not necessarily mandatory, and some features or steps may be omitted. The order of the steps described in any of the drawings may be changed as appropriate.

Some or all of the above example embodiments can also be described as following supplementary notes, but are not limited to the following.

### (Supplementary note 1)

A polarization conversion element including

an optical waveguide extending in a first direction and having, as a width direction, a second direction orthogonal to the first direction in a cross section perpendicular to the first direction, and

a low refractive index layer having a refractive index lower than a refractive index of the optical waveguide, the low refractive index layer extending in the first direction and having, as a width direction, the second direction in the cross section perpendicular to the first direction and being provided to be separated from the optical waveguide in a third direction orthogonal to the first and second directions and to overlap a part of the optical waveguide as viewed along the third direction, in which

the optical waveguide is divided into a first region, a second region, a third region, a fourth region, and a fifth region from an incident side toward an emission side of light along the first direction, and

the low refractive index layer is provided between an end portion on the incident side of the light of the second region and an end portion on the emission side of the light of the fifth region in such a way as to extend with a width wider than a width of the optical waveguide, and

in the first region, the width of the optical waveguide is a width at which light in a fundamental mode is selectively guided, and

in the second region, the width of the optical waveguide expands from the incident side toward the emission side of the light, and a width of the low refractive index layer expands from the incident side toward the emission side of the light, and

in the third region, widths of the optical waveguide and the low refractive index layer are equal to respective widths at an end portion on the emission side of the light of the second region, and

in the fourth region, the width of the optical waveguide expands from the incident side toward the emission side of the light, and the width of the low refractive index layer is equal to the width in the third region, and

in the fifth region, the width of the optical waveguide is equal to a width at an end portion on the emission side of the light of the fourth region, and the width of the low refractive index layer reduces from the incident side toward the emission side of the light.

### (Supplementary note 2)

The polarization conversion element according to supplementary note 1, in which a ratio of the width of the low refractive index layer to the width of the optical waveguide in the third region is equal to or more than 1.2.

### (Supplementary note 3)

The polarization conversion element according to supplementary note 2, in which the ratio of the width of the low refractive index layer to the width of the optical waveguide in the third region is equal to or more than 1.4.

### (Supplementary note 4)

The polarization conversion element according to any one of supplementary notes 1 to 3, in which the optical waveguide and the low refractive index layer are provided in such a way that central axes in the first direction of the optical waveguide and the low refractive index layer coincide with each other as viewed along the third direction.

### (Supplementary note 5)

The polarization conversion element according to supplementary note 4, in which the optical waveguide and the low refractive index layer respectively have symmetrical shapes with respect to the central axis in the first direction.

### (Supplementary note 6)

The polarization conversion element according to any one of supplementary notes 1 to 5, in which

the width of the low refractive index layer at the end portion on the incident side of the light of the second region is a width capable of suppressing reflection due to incidence of the light to equal to or less than a desired value, and

the width of the low refractive index layer at the end portion on the emission side of the light of the fifth region is a width capable of suppressing reflection due to incidence of the light to equal to or less than a desired value.

### (Supplementary note 7)

The polarization conversion element according to any one of supplementary notes 1 to 6, in which

the second region includes a sixth region on the incident side of the light and a seventh region on the emission side of the light, and

in the sixth region, the width of the optical waveguide is equal to the width in the first region, and the width of the low refractive index layer expands from the incident side toward the emission side of the light, and

in the seventh region, the width of the optical waveguide expands from the incident side toward the emission side of the light, and the width of the low refractive index layer is equal to the width at the end portion on the emission side of the light of the sixth region.

### (Supplementary note 8)

The polarization conversion element according to supplementary note 7, in which

the optical waveguide extends in such a way that the width contiguously changes in the fourth and seventh regions, and

the low refractive index layer extends in such a way that the width contiguously changes in the fifth and sixth regions.

### (Supplementary note 9)

The polarization conversion element according to supplementary note 8, in which

the optical waveguide has a tapered shape in which the width contiguously changes in the fourth and seventh regions, and

the low refractive index layer has a tapered shape in which the width contiguously changes in the fifth and sixth regions.

### (Supplementary note 10)

The polarization conversion element according to any one of supplementary notes 7 to 9, in which

a first connection region is inserted between the sixth region and the seventh region,

a second connection region is inserted between the fourth region and the fifth region, and

in the first and second connection regions, the optical waveguide and the low refractive index layer extend with constant widths.

### (Supplementary note 11)

The polarization conversion element according to any one of

supplementary notes 7 to 9, in which

a first connection region is inserted between the sixth region and the seventh region, and

in the first connection region, the optical waveguide and the low refractive index layer extend with constant widths.

### (Supplementary note 12)

The polarization conversion element according to any one of supplementary notes 1 to 8, in which

a second connection region is inserted between the fourth region and the fifth region, and

in the second connection region, the optical waveguide and the low refractive index layer extend with constant widths.

### (Supplementary note 13)

The polarization conversion element according to any one of supplementary notes 1 to 12, in which the light of the fundamental mode is light of a TE0 mode and a TM0 mode.

### (Supplementary note 14)

The polarization conversion element according to any one of supplementary notes 1 to 13, in which the polarization conversion element is configured as a silicon photonics element.

### (Supplementary note 15)

The polarization conversion element according to supplementary note 14, in which

the optical waveguide includes silicon, and

the low refractive index layer includes silicon nitride.

### (Supplementary note 16)

The polarization conversion element according to supplementary note 15, in which the optical waveguide and the low refractive index layer are embedded in a clad layer.

### (Supplementary note 17)

The polarization conversion element according to supplementary note 16, in which the clad layer includes silicon oxide.

1. A polarization conversion element comprising:
an optical waveguide extending in a first direction and having, as a width direction, a second direction orthogonal to the first direction in a cross section perpendicular to the first direction; and
a low refractive index layer having a refractive index lower than a refractive index of the optical waveguide, the low refractive index layer extending in the first direction and having, as a width direction, the second direction in the cross section perpendicular to the first direction and being provided to be separated from the optical waveguide in a third direction orthogonal to the first and second directions and to overlap a part of the optical waveguide as viewed along the third direction, wherein
the optical waveguide is divided into a first region, a second region, a third region, a fourth region, and a fifth region from an incident side toward an emission side of light along the first direction, and
the low refractive index layer is provided between an end portion on the incident side of the light of the second region and an end portion on the emission side of the light of the fifth region in such a way as to extend with a width wider than a width of the optical waveguide, and
in the first region, the width of the optical waveguide is a width at which light in a fundamental mode is selectively guided, and
in the second region, the width of the optical waveguide expands from the incident side toward the emission side of the light, and a width of the low refractive index layer expands from the incident side toward the emission side of the light, and
in the third region, widths of the optical waveguide and the low refractive index layer are equal to respective widths at an end portion on the emission side of the light of the second region, and
in the fourth region, the width of the optical waveguide expands from the incident side toward the emission side of the light, and the width of the low refractive index layer is equal to the width in the third region, and
in the fifth region, the width of the optical waveguide is equal to a width at an end portion on the emission side of the light of the fourth region, and the width of the low refractive index layer reduces from the incident side toward the emission side of the light.

2. The polarization conversion element according to claim 1, wherein a ratio of the width of the low refractive index layer to the width of the optical waveguide in the third region is equal to or more than 1.2.

3. The polarization conversion element according to claim 2, wherein the ratio of the width of the low refractive index layer to the width of the optical waveguide in the third region is equal to or more than 1.4.

4. The polarization conversion element according to claim 1, wherein the optical waveguide and the low refractive index layer are provided in such a way that central axes in the first direction of the optical waveguide and the low refractive index layer coincide with each other as viewed along the third direction.

5. The polarization conversion element according to claim 4, wherein the optical waveguide and the low refractive index layer respectively have symmetrical shapes with respect to the central axis in the first direction.

6. The polarization conversion element according to claim 1, wherein
the width of the low refractive index layer at the end portion on the incident side of the light of the second region is a width capable of suppressing reflection due to incidence of the light to equal to or less than a desired value, and
the width of the low refractive index layer at the end portion on the emission side of the light of the fifth region is a width capable of suppressing reflection due to incidence of the light to equal to or less than a desired value.

7. The polarization conversion element according to claim 1, wherein
the second region includes a sixth region on the incident side of the light and a seventh region on the emission side of the light, and
in the sixth region, the width of the optical waveguide is equal to the width in the first region, and the width of the low refractive index layer expands from the incident side toward the emission side of the light, and
in the seventh region, the width of the optical waveguide expands from the incident side toward the emission side of the light, and the width of the low refractive index layer is equal to the width at the end portion on the emission side of the light of the sixth region.

8. The polarization conversion element according to claim 7, wherein
the optical waveguide extends in such a way that the width contiguously changes in the fourth and seventh regions, and
the low refractive index layer extends in such a way that the width contiguously changes in the fifth and sixth regions.

9. The polarization conversion element according to claim 8, wherein
the optical waveguide has a tapered shape in which the width contiguously changes in the fourth and seventh regions, and
the low refractive index layer has a tapered shape in which the width contiguously changes in the fifth and sixth regions.

10. The polarization conversion element according to claim 7, wherein
a first connection region is inserted between the sixth region and the seventh region,
a second connection region is inserted between the fourth region and the fifth region, and
in the first and second connection regions, the optical waveguide and the low refractive index layer extend with constant widths.

11. The polarization conversion element according to claim 7, wherein
a first connection region is inserted between the sixth region and the seventh region, and
in the first connection region, the optical waveguide and the low refractive index layer extend with constant widths.

12. The polarization conversion element according to claim 1, in wherein
a second connection region is inserted between the fourth region and the fifth region, and
in the second connection region, the optical waveguide and the low refractive index layer extend with constant widths.

13. The polarization conversion element according to claim 1, wherein the light of the fundamental mode is light of a TE0 mode and a TM0 mode.

14. The polarization conversion element according to claim 1, wherein the polarization conversion element is configured as a silicon photonics element.

15. The polarization conversion element according to claim 14, wherein
the optical waveguide includes silicon, and
the low refractive index layer includes silicon nitride.

16. The polarization conversion element according to claim 15, wherein the optical waveguide and the low refractive index layer are embedded in a clad layer.

17. The polarization conversion element according to claim 16, wherein the clad layer includes silicon oxide.
